(19) United States
(12) Patent Application Publication
(10) Pub. No.: US 2011/0091835 A1
(43) Pub. Date: Apr. 21, 2011

(54) MOUTHPIECE THAT ADJUSTS TO USER ARCH SIZES AND SEALS FROM OXYGEN EXPOSURE

(76) Inventor: Jonathan B. LEVINE, Purchase, NY (US)

(21) Appl. No.: 12/246,012

(22) Filed: Oct. 6, 2008

(51) Int. Cl. A61C 17/00

(52) U.S. Cl. 433/29

(57) ABSTRACT

A mouthpiece that adjusts manually to accommodate a broad range of different size sets of upper and lower teeth in the mouth and yet seals the treatment area from oxygen exposure. The mouthpiece includes light emitting diodes and heat generating resistors all arranged in an array. A series of parallel texture bands are provides to guide and direct the light from the LEDs to diffuse generally evenly onto teeth to be treated. The seal arises from an inner surface of the mouthpiece tilting inwardly so that a seal bead seals in the vicinity of the gum above the teeth to be treated.

### BACKGROUND OF THE INVENTION

1. Field of the Invention

The present invention relates to a mouthpiece containing lamps to expose electromagnetic radiation to effect oral treatment and, specifically, to aid the activation of an adhesive whitening gel to whiten teeth. The present invention may also be used to kill harmful bacteria in the mouth through the electromagnetic radiation exposure. The mouthpiece adjusts manually to accommodate a broad range of user sizes, yet seals the treatment area from oxygen exposure.

2. Description of Related Art

Conventional teeth whitening in the dental office takes up to two hours, may be painful and is often costly with noticeable regression beginning in about seven days after the treatment. Improved whitening results are experienced in a professional setting using white light in the 300-990 nm range, but this procedure may be costly and time consuming. Over-the-counter products suffer from other deficiencies, such as difficulty of use, irritation to the fingers and results usually take 7-10 days. Often, there is only minimal improvement. The consumer needs a customizable whitening alternative that yields results similar to professional whitening, but at the convenience of the home.

Dentist-supervised tooth whitening involves the controlled use of carbamide or hydrogen peroxide, tailored to a particular patient. Dentists may administer in-office treatments or at-home treatments. Before the tooth whitening treatment, most dentists clean the teeth, fill cavities, and ensure the patient's gums are healthy.

Most in-office tooth whitening systems use 15 to 35 percent hydrogen peroxide gels, sometimes coupled with a high intensity light to expedite the bleaching chemical reaction.

The in-office procedure involves the dentist gently cleaning the teeth with pumice and then applying a protective barrier on the gums. The dentist then applies hydrogen peroxide paste on the teeth for several minutes, rinses the hydrogen peroxide paste off, and usually reapplies the hydrogen peroxide paste several times. The procedure can achieve about four to six shades of whitening after only one 40-minute treatment.

At-home systems will often use 10 to 20 percent carbamide peroxide gels that also contain glycerin, carbomer, sodium hydroxide, water, and flavoring agents. Some gels that contain more than 10 percent carbamide peroxide will also include sodium fluoride to reduce sensitivity and strengthen teeth.

To begin the at-home procedure, the dentist takes impressions (molds) of the mouth, and then has soft, custom mouth trays made. In administering the treatment, the user places a thin ribbon of the gel into the tray and wears it for two hours during the day, or while sleeping. Most whitening occurs in one to two weeks. In difficult cases, trays may need to be worn for up to six weeks.

A combination of in-office and at-home systems can achieve up to 12 to 15 shades of whitening. Such a procedure is considered safe and effective when monitored by a dentist.

Dentist supervised systems have advantages and disadvantages when compared to over-the-counter tooth whitening products. The main advantage of the dentist supervised system is that the dentist can determine if tooth whitening should be performed and if it will be effective for the patient. Patients with decayed teeth, infected gums, white spots on their teeth, and multiple tooth colored fillings or crowns (caps) on the front teeth may not be good candidates for tooth whitening.

The dentist can also help decide what type of tooth whitening is required (in-office, at-home or both) and the concentration of the whitening gels. The dentist can monitor and treat patients who experience sensitivity to the whitening agents and modify the procedure for those who are having difficulty getting optimal results. Finally, the dentist can help the patient explore porcelain or resin veneers, tooth colored fillings, gum lifts and tooth shaping used with or without tooth whitening. With the help of the dentist, the patient's cosmetic dental goals may be more easily attained.

The disadvantages of dentist supervised whitening systems include higher cost and longer time required to get started. The in-office and at-home tooth whitening systems can cost between $300-$1,000 (sometimes more). In most cases, at-home systems cost less than the in-office systems. With the dentist supervised systems, there may be a wait to get started. You have to schedule an appointment, wait to be seen and evaluated, and then be treated.

Whitening results are best achieved when there is high frequency of use of the whitening agent, in a safe manner without high concentrations of whitening agents that can burn the gum tissue. By increasing the frequency of the whitening by giving the consumer the ability to whiten at home, the regression of the whitening is greatly reduced or even eliminated.

It is desired to provide a whitening device (mouthpiece) that is coupled with a delivery system of the whitening gel and an adhesive that keeps a photosensitive agent, such as carbamide or hydrogen peroxide, targeted to the area to be whitened, i.e. to the tooth surface. Such a whitening device preferably causes no harmful breakdown by-products, and is hygienically delivered in a single dose.

Further, it is desired to have an adjustable whitening device (mouthpiece) to accommodate a broad range of different size sets of upper or lower teeth of users. It is further desired that the whitening device seal off the area in the mouth to be treated to reduce the amount of oxygen exposure.

In addition, harmful bacteria responsible for causing gum disease in the mouth, specifically, the gram negative anaerobic bacteria, are killed by exposure to electromagnetic radiation in the form of ultraviolet light. It would therefore be desirable for a consumer to expose such bacteria to ultraviolet light as well.

### SUMMARY OF THE INVENTION

One aspect of the invention resides in an intra-oral whitening device or mouthpiece suited to create a whitening and heat effect to increase a reaction rate of a photosensitive agent, such as carbamide or hydrogen peroxide gel. The person whose teeth are to be whitened can wear the device and whiten his/her teeth without the need of a professional office in a safe, effective, convenient and economical fashion.

The intra oral whitening device (or mouthpiece) of the present invention allows whitening teeth in the convenience of one's home with LED-based white light technology and to customize the whitening procedure safely and effectively without the need for a dentist. The mouthpiece adjusts its orientation manually to accommodate a broad range of different size sets of upper or lower teeth of users and to seal a treatment area in the mouth against exposure to oxygen.

Another aspect of the invention is to expose harmful bacteria in the mouth to electromagnetic radiation, such as ultraviolet light. By doing so, the spread of gum disease caused by the harmful bacteria, such as gram negative anaerobic bacteria, is halted because the ultraviolet light kills the harmful bacteria.

### BRIEF DESCRIPTION OF THE DRAWING

For a better understanding of the present invention, reference is made to the following description and accompanying drawings, while the scope of the invention is set forth in the appended claims:

FIG. 1 is an isometric view of a dental mouthpiece in accordance with the invention.

FIG. 2 is a partially broken isometric view of the dental mouthpiece of FIG. 1.

FIGS. 3A-3C are top views of the dental mouthpiece of FIG. 1 that illustrate how the dental mouthpiece is adjusted to open from the position reflected by FIG. 3A to that of FIG. 3B and to close from the position reflected by FIG. 3A to that of FIG. 3C.

FIG. 4 is a cross-section through a centerline of the dental mouthpiece of FIG. 1.

FIG. 5 is cross-section of the dental mouthpiece of FIG. 1 with respect to a user's tooth.

### DETAILED DESCRIPTION OF THE INVENTION

During a teeth whitening treatment in a dental office, a whitening gel is applied to the teeth and a protective barrier is placed on the gums, the mucosa and lips to prevent burning of the tissues by the high concentration of hydrogen peroxide in the whitening gel. A leading edge of the whitening gel is placed on a tooth surface. An LED-based white light is placed a few inches from such a tooth surface to help activate free radical oxygen, most of which becomes lost into the air. In this invention, the mouthpiece seals or encloses a photosensitive agent, such as carbamide or hydrogen peroxide gel, to prevent the loss of the active electrons of the photosensitive agent (carbamide or hydrogen peroxide) into the air.

The mouthpiece holds LED-based white light sources. A power source, which may be remote from the mouthpiece, is in electrical connection with the LED-based white light sources via a wire, The power source energizes the LED-based white light sources, which generate light rays. The light rays strike the tooth surface on the front and the edge and the back of the edge while the mouthpiece is in its intended position relative to the tooth surface.

Further, a “closed system” created by the mouthpiece or guard that seals or encloses (against exposure to the atmosphere) is efficient for keeping the active free radical oxygen in close proximity to the teeth to enable their movement onto the tooth surface to breakdown the color pigments inside the tooth. A much lower concentration of the carbamide or hydrogen peroxide gel may be used in comparison to what would be needed to achieve like results in an “open system” that did not seal or enclose the photosensitive agent (carbamide or hydrogen peroxide) from exposure to atmosphere.

Indeed, the whitening device (mouthpiece) of the present invention may be used for seven to ten consecutive days with little to no sensitivity to the teeth and gums. This seven to ten consecutive day use constitutes a higher frequency of use than is available in conventional professional whitening techniques and helps avoid a regression phenomenon that has been observed in the professional whitening technique.

The mouthpiece 10 adjusts to a broad range of user dental arch sizes (curvature attributed to lower or upper sets of teeth). It also distributes light and heat in a controlled and focused fashion and provides a means of sealing an area being treated from exposure to oxygen.

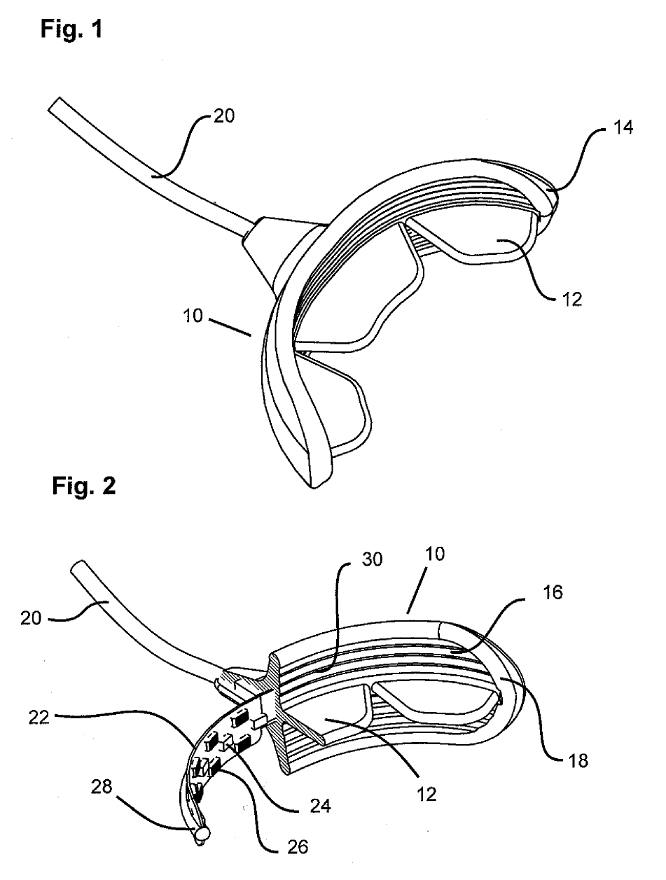

Referring to FIG. 1, the mouthpiece 10 includes a bite surface 12 formed of segments. The bite surface 12 is central and perpendicular to the main body 14.

Referring to FIG. 2, the mouthpiece 10 is formed of a clear, elastomeric, molded outer shape 14 that encases a flexible circuit board 22. There is a deformable frame 28 that holds the circuit board 22 during fabrication and may be bent by the user to adjust the orientation of the mouthpiece 10 to set the arch for comfort in the user's mouth.

A series of super bright light emitting diodes (LEDs) 24 and heat generating resistors 26 are arrayed on an inner, lingual side of the flexible circuit board 22. The power cord 20 is centrally attached to the outer surface.

A parallel series of textured bands 16, whose surface texture resembles elongated convex surfaces configured to channel LED light, are formed on the lingual side of the outer shape 14 for the purposes of LED light diffusion over the surface of the tooth being treated.

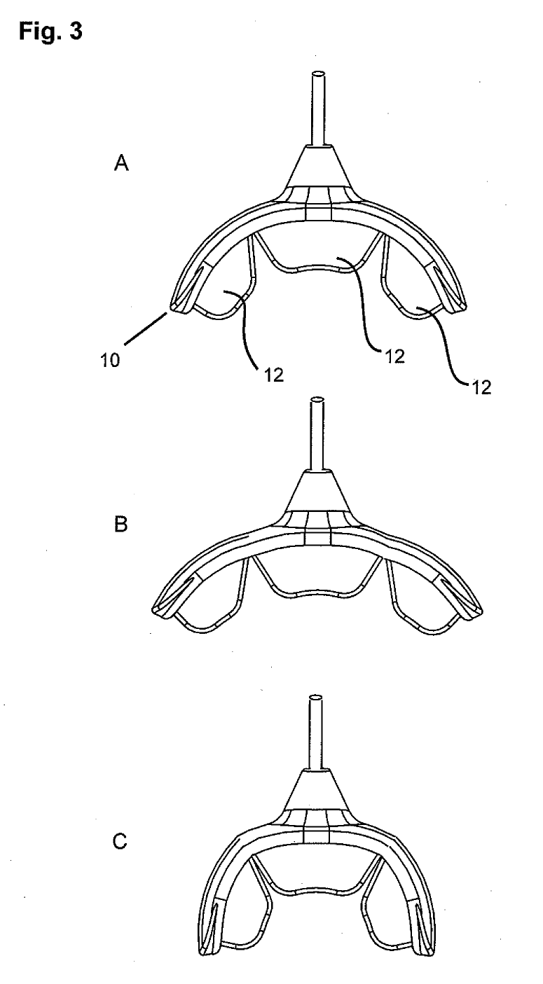

Referring to FIG. 3A, areas between the segmented bite surfaces 14 allow the device to open as in FIG. 3B or close as in FIG. 3C.

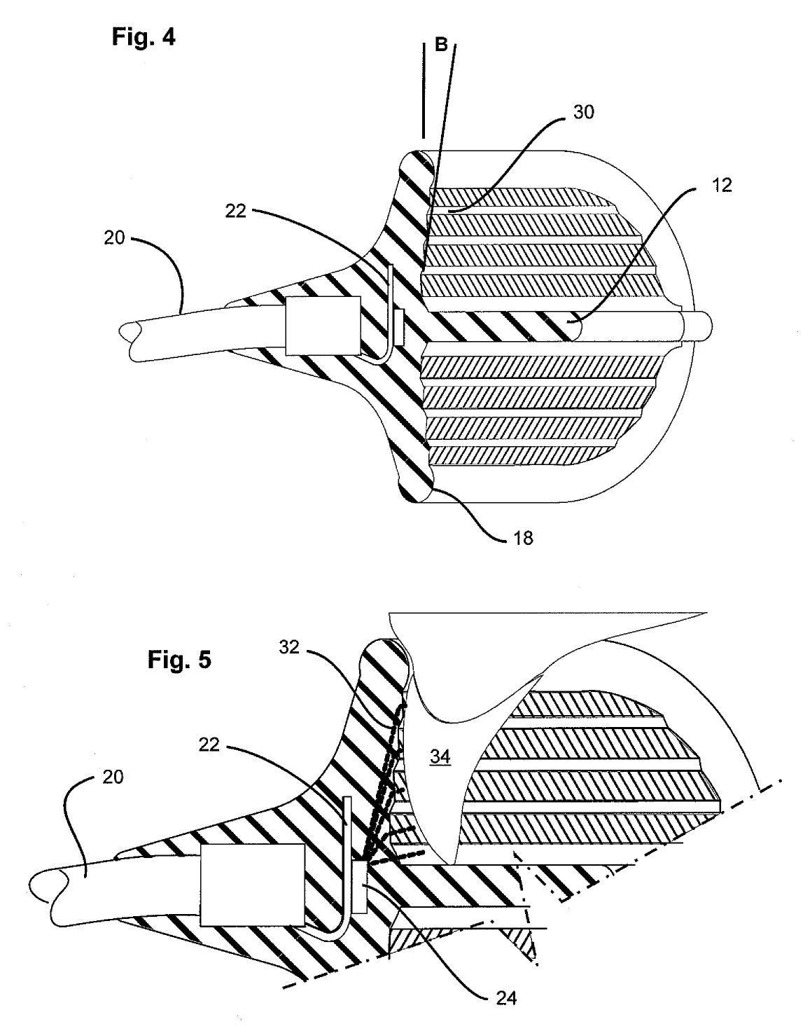

Referring to FIG. 4, an inner surface 30 of the mouthpiece 10 tilts inward at an angle of 5 to 15 degrees as noted by B to seal the seal bead 18 and borders the edge of the mouthpiece 10.

Referring to FIG. 5, the inward tilt of the inner surface 30 allows the seal bead 18 to contact the gum above the tooth. This contact provides a barrier seal to both retain the whitening gel and to prevent oxygen from entering the treatment area of the tooth (that is to be treated with the whitening gel).

The light 32 emitted by the LEDs 24 is guided and directed to more evenly illuminate the surface of the teeth by the textured bands 16. The texture of the textured bands 16 provides surfaces that are closer to perpendicular to the light path and less reflective than the generally polished surface of the mouthpiece.

While the foregoing description and drawings represent the preferred embodiments of the present invention, it will be understood that various changes and modifications may be made without departing from the spirit and scope of the present invention.

What is claimed is:

1. A mouthpiece, comprising a main body and a bite surface that extends outward from the main body, the main body containing a deformable frame that holds a flexible circuit board, the deformable frame being configured to bend under manual force to adjust an orientation of the main body to define an arch configuration; and a plurality of light emitting diodes and heat generating resistors arranged in an array on the flexible circuit board.

2. The mouthpiece of claim 1, wherein the main body encases the flexible circuit board, the plurality of light emitting diodes and heat generating resistors being on a lingual side of the flexible circuit board.

3. The mouthpiece of claim 1, further comprising a power cord attached to a central region of an outside facing surface of the flexible circuit board.

4. The mouthpiece of claim 1, further comprising a parallel series of textured bands on a lingual side of the main body to diffuse light from the light emitting diodes toward areas to be treated.

5. The mouthpiece of claim 1, wherein the bite surface is segmented into a plurality of spaced apart segments that allow room for the deformable frame to flex to selectively re-orient a configuration of the main body between open and closed positions.

6. The mouthpiece of claim 1, wherein the mouthpiece has an inner surface that inwardly tilts within an angular range of 5 to 15 degrees to seal a seal bead, which borders an edge of the mouthpiece.

7. The mouthpiece of claim 6, wherein the inner surface inwardly tilts to allow the seal bead to contact a gum above a tooth, the contact providing a barrier seal to both retain a whitening gel and to prevent oxygen from entering an area of the tooth to be treated by the whitening gel.

8. The mouthpiece of claim 4, wherein the mouthpiece includes a polished surface, the textured bands are arranged to guide a direct the light from the light emitting diodes so as to more evenly illuminate surfaces of the teeth than would otherwise be the case without the textured bands being present, the textured bands having a surface texture that is closer to being perpendicular to a path of the light and less reflective than the polished surface of the mouthpiece.
